(19) United States
(12) Patent Application Publication
(10) Pub. No.: US 2009/0211021 A1
(43) Pub. Date: Aug. 27, 2009

(54) Housing to Facilitate the Alignment and Replacement of a Faucet Body of a Water Faucet

(76) Inventor: Arthur Gabriele, Woodhaven, NY (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/037,151

(22) Filed: Feb. 26, 2008

(51) Int. Cl. F16K 27/00

(52) U.S. Cl. 4/678; 137/801

(57) ABSTRACT

A housing is provided to facilitate the alignment and replacement of a faucet body of a water faucet. The faucet body is situated behind a vertical bathroom wall adjacent a bathtub. The vertical wall has a showerhead and a bathtub spout mounted thereto. The faucet body includes hot and cold water inlet openings arranged for coupling to hot and cold water supply pipes located behind the vertical wall. The faucet body includes outlet openings for coupling to outlet pipes located behind the vertical wall for supplying temperature regulated water to the bathtub spout and showerhead. The housing comprises a mounting flange provided for mounting the housing to an opening in the bathroom wall in proximity to the water faucet body. A box section extends from the mounting flange and through the bathroom wall opening. The box section includes a horizontal upper wall, a horizontal lower wall and an access opening therebetween. The upper and lower walls include a plurality of openings for aligning the water supply pipes and the outlet pipes to facilitate the coupling and decoupling of the pipes to the inlet and outlet openings of the faucet body. A panel is provided for attachment to the mounting flange.

### FIELD OF THE INVENTION

The present invention relates generally to the repair and replacement of plumbing components hidden behind a bathroom wall. More particularly, the present invention relates to a housing to facilitate the alignment and replacement of a faucet body of a water faucet.

### BACKGROUND OF INVENTION

Large buildings such as modern apartment buildings generally have bathrooms in each apartment unit often including a bathtub having a shower. Bath fixtures are often permanently affixed to a bathroom wall adjacent the bathtub such as a shower head, a bathtub spout, one or more faucet knobs for regulating water temperature, and possibly a mechanism for diverting water from the bathtub spout to the shower head. Plumbing components bringing water to the bathroom fixtures, e.g., such as hot and cold water supply pipes, a faucet body, plumbing lines to the shower head and bathtub spout, and other plumbing components such as fittings, caps, etc., are often housed behind the bathroom wall. In this manner, the plumbing components are out of view during bathroom use.

Walls adjacent the bathtub are often covered with wall coverings extending from the bathtub up to the point where the shower head is located to protect the drywall or cement board (or whatever material is under the wall covering) from water damage during use of the bathtub and shower. Such wall coverings may include ceramic tiles, plastic paneling, or other decorative elements. Over time or as the result of continuous use, it often becomes necessary to replace plumbing components hidden behind the bathroom wall. For example, the faucet body is a plumbing component often requiring early repair or replacement. Due to an apartment's configuration, often it is impractical to provide a panel located somewhere outside of the bathtub for gaining access to the hidden plumbing components. Under these circumstances, gaining access to the hidden plumbing components is conventionally accomplished by defacing the wall on which the bathroom fixtures are affixed including the removal of tile or other wall covering using a hammer and chisel and cutting through drywall or other material with a drywall saw or a compass saw. Such demolition can be somewhat dangerous and may result in an increased risk of injury.

Once the failed or faulty plumbing component has been removed and replaced, the bathroom wall and wall covering must be replaced. This is time consuming and expensive to the building owner, especially when multiplied over the number of bathrooms in a large apartment building or hospital, thus requiring almost continuous demolition and repair of walls and wall coverings. In addition to plumbers, carpenters or others specializing in the demolition and repair of walls and wall coverings are needed to complete this job. Therefore, there is a need to provide easy access to hidden plumbing components from within the bathtub area that is low in cost, reduces the risk of injury associated with conventional methods, and retains the pristine appearance of bathroom walls.

### SUMMARY OF THE INVENTION

A housing is provided to facilitate the alignment and replacement of a faucet body of a water faucet for a bathtub. The faucet body is situated behind a vertical bathroom wall adjacent a bathtub. The vertical wall has a shower head and a bathtub spout mounted thereto. The faucet body includes hot and cold water inlet openings arranged for coupling to hot and cold water supply pipes located behind the vertical wall. The faucet body includes outlet openings for coupling to outlet pipes located behind the vertical wall for supplying temperature regulated water to the bathtub spout and shower head. The housing comprises a mounting flange provided for mounting the housing to an opening in the bathroom wall in proximity to the water faucet body. A box section extends from the mounting flange and through the bathroom wall opening. The box section includes a horizontal upper wall, a horizontal lower wall and an access opening therebetween. The upper and lower walls include a plurality of openings for aligning the water supply pipes and the outlet pipes to facilitate the coupling and decoupling of the pipes to the inlet and outlet openings of the faucet body. A panel is provided for attachment to the mounting flange.

### BRIEF DESCRIPTION OF THE DRAWINGS

FIG. 1 is a perspective view of the housing to facilitate the alignment and replacement of a faucet body of a water faucet of the present invention situated within a wall of a bathroom adjacent a bathtub;

FIG. 2 is a close-up perspective view of the housing assembly of the present invention with plumbing water supply pipes and outlet pipes extending through openings therein and connected to a faucet body housed therein;

FIG. 3 is a cross-sectional view taken along line 3-3 of FIG. 1 of the present invention; and,

FIG. 4 is a cross-sectional view taken along line 4-4 of FIG. 3 of the present invention.

### DETAILED DESCRIPTION OF THE INVENTION

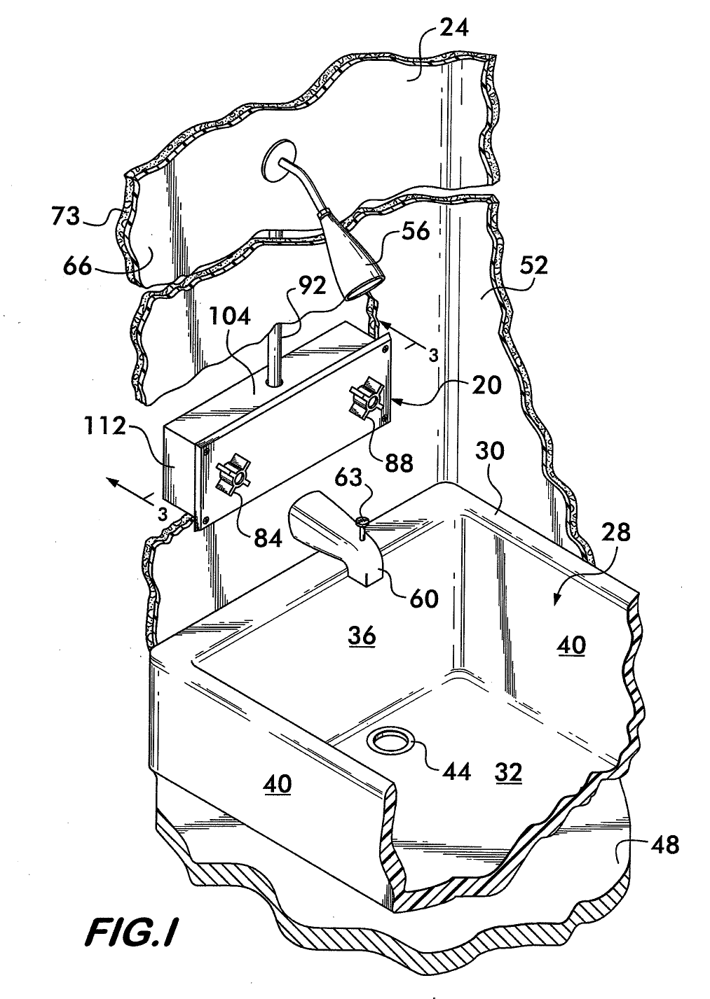

Referring now in detail to the various figures of the drawings wherein like reference characters refer to like parts, there is shown at 20 in FIG. 1, a housing to facilitate the alignment and replacement of a faucet body of a water faucet, constructed in accordance with this invention. The housing 20 of the present invention is shown mounted to and extending through an opening of a first wall 24 of a bathroom. The wall 24 is located adjacent a bathtub 28. At least two additional walls are situated adjacent other sides of the bathtub 28. A second wall 52 is shown extending in a generally perpendicular direction from the first wall 24. A third wall (not shown), which faces the first wall 24 is located adjacent the foot of the bath tub 28. The bathtub 28 includes a rim 30, a bottom 32, an end wall 36, side walls 40, and a drain 44. The bathtub 28 is situated upon a floor 48 of the bathroom. A shower head 56 and a bathtub spout 60 are also mounted to the first wall 24. The bathtub spout 60 includes a lever 63 for diverting running water from the bathtub spout 60 to the shower head 56.

Each wall 24, 52 surrounding the bathtub 28 is formed of two layers. The first layer 66 is a wall covering, such as ceramic tiles (not shown), continuous plastic paneling (shown in FIG. 1), or other decorative elements, while the second layer 73 is drywall or cement board, or whatever material is under the wall covering layer 66. As shown in FIG. 1, the wall covering layer 66 extends upwardly from the bathtub 28 above the location where the shower head 56 is located. The wall covering layer 66 is provided to protect the drywall or cement board located therebeneath from water damage during use of the bathtub and shower.

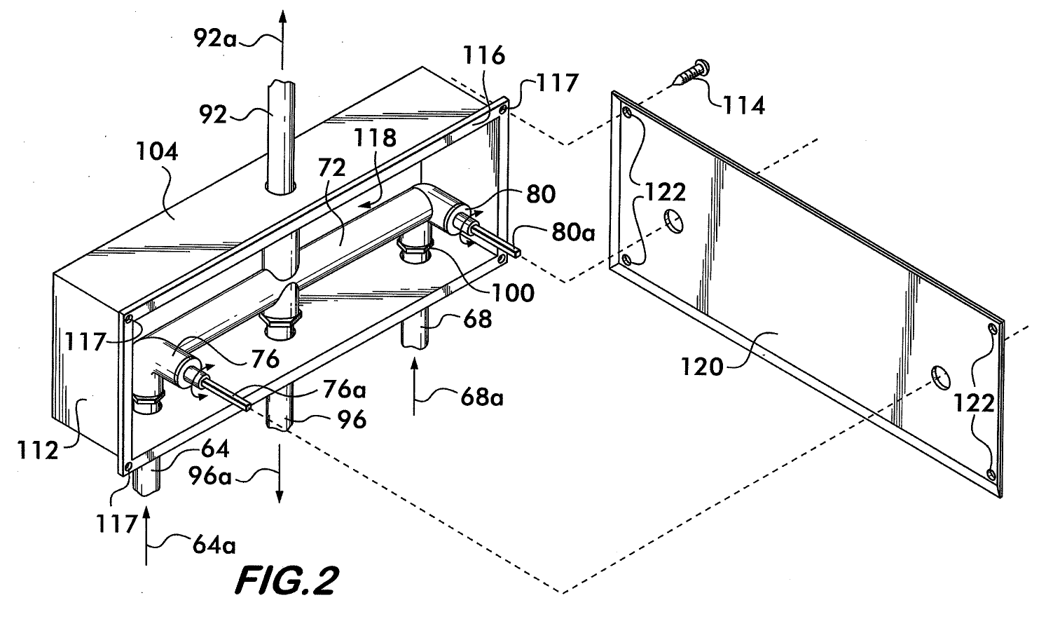

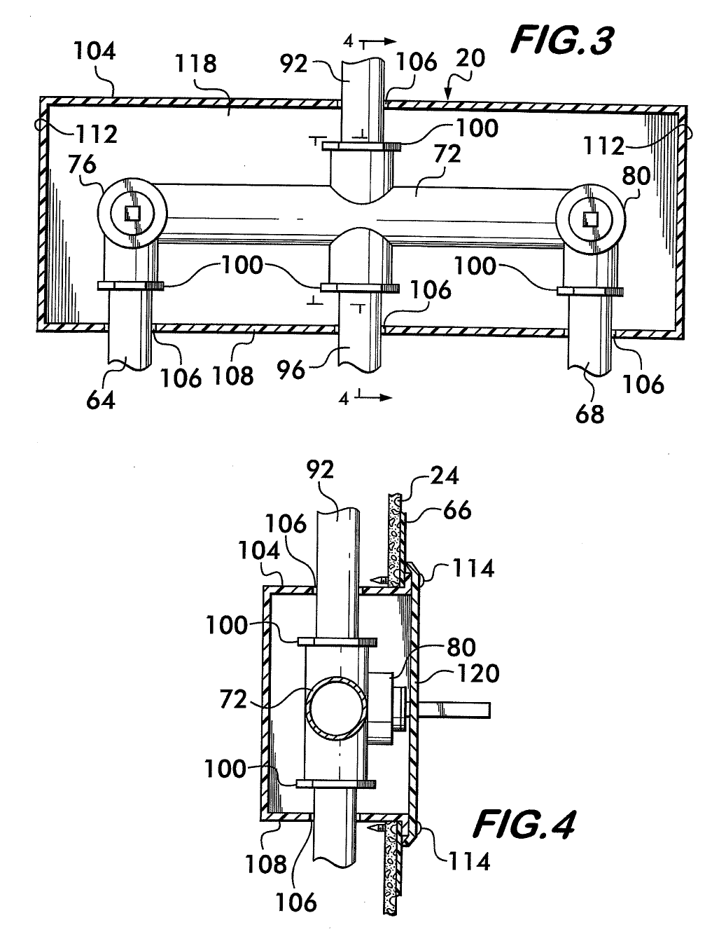

Referring now to FIGS. 2 and 3, plumbing components, e.g., pipes 64, 68, 92 and 96, connected to a faucet body 72, are located behind the wall 24 of the bathroom so they are out of view. Hot and cold water supply pipes, indicated at 64 and 68 respectively, are provided for conveying hot and cold water in the direction indicated by arrows 64a and 68a into the faucet body 72 through valves 76 and 80. Outlet pipes indicated at 92 and 96 convey water from the faucet body 72 in the direction indicated by arrows 92a and 96a. These supply and outlet pipes 64, 68, 92 and 96, may be constructed of any suitable material and preferably are constructed of copper which has been demonstrated to provide these pipes with a long service life.

As shown in FIGS. 2 and 3, the faucet body 72 includes two valves 76 and 80, one on each side thereof. One valve 76 regulates the flow of hot water into the faucet body 72 while the other valve 80 regulates the flow of cold water thereto. Alternatively, the faucet body 72 may include a single valve (not shown) for regulating the flow of both hot and cold water into the faucet body 72. Each valve 76 and 80 includes a stem, indicated at 76a and 80a, which extends through the wall 24 (FIG. 1) and to which a faucet handle, indicated at 84 and 88 (FIG. 1), is attached. The faucet handles 84 and 88 may be manipulated by a user during a bath or shower to regulate the water temperature being delivered to the shower head 56 or bathtub spout 60, through outlet pipes 92 and 96, respectively, in the direction indicated by arrows 92a and 96a.

The faucet body 72 is connected to supply pipes 64 and 68 and to outlet pipes 92 and 96 by means of unions 100. Utilizing a suitable tool, e.g., a pipe wrench, these unions 100 may be rotated to detach the faucet body 72 from the pipes 64, 68, 92, 96 so that the faucet body 72 may be removed and replaced upon its failure or once it has reached the end of its service life. Often, the valves 76 and 80, which include several components which are subject to wear over time, require replacement, thus requiring access to the faucet body for replacement.

Referring now to FIGS. 1 through 3, the housing 20 of the present invention includes a top wall 104, a bottom wall 108, and side walls 112, each of which extends through a pre-cut opening in the wall 24. Preferably, the opening in the wall 24 is cut or created at the time of initial construction of the bathroom. Together, the walls 104, 108 and 112 form a rectangular box-like structure having an opening 118 therethrough which provides easy access to the faucet body 72 for replacement. Extending at the front end of the box-like structure is a flange 116, which is provided with openings 117 in the corners thereof to permit the housing 20 to be secured to the bathroom wall 24 by any suitable means, e.g., screws 114. The housing 20 is also provided with a panel 120 arranged for covering the opening 118 when access is not required. The panel 120 includes openings 122 through which the screws 114 may pass for attachment to the flange. The panel may include a decorative surface, e.g., a tile or a silver or gold decorative surface.

Referring now to FIGS. 3 and 4, the top wall 104 and bottom wall 108 of the box-like structure each includes one or more circular openings 106 through which the supply pipes 64, 68 and outlet pipes 92 and 96 extend. These openings 106 provide guidance for the supply and outlet pipes 64, 68, 92 and 96 and facilitate the joinder of a replacement faucet body 72 to these pipes through use of the unions 100.

In this manner, once the service life of the faucet body 72 has been reached or in the event of a failure of the faucet body 72 prior to its service life, the panel 120 may be removed from the wall 24 by removing the a plurality of fasteners, e.g., screws 114. Once the panel 120 has been removed, access to the faucet body 72 may be obtained through the opening 118. The unions 100 may be removed utilizing a suitable tool, e.g., plumber's wrench, to enable removal of the failed faucet body 72 from the pipes 64, 68, 92 and 96. Once a replacement faucet body 72 is positioned in place, the unions 100 may be adjusted to reconnect the faucet body 72 to the supply and outlet pipes 64, 68, 92 and 96. Thereafter, the panel 120 may be reattached to the wall 24 utilizing suitable fasteners, e.g., screws 114. In this manner, demolition of the wall 24, e.g., cutting through drywall and removing tile or other wall coverings, to gain access for the removal and replacement of a faulty faucet body, and the related dangers and expenses associated therewith have been avoided. Without further elaboration the foregoing will so fully illustrate my invention that others may, by applying current or future knowledge, adapt the same for use under various conditions of service.

What is claimed:

1. A housing to facilitate the alignment and replacement of a faucet body of a water faucet, the faucet body being situated behind a vertical bathroom wall adjacent a bathtub, the vertical wall having a shower head and a bathtub spout mounted thereto, the faucet body including hot and cold water inlet openings arranged for coupling to hot and cold water supply pipes located behind the vertical wall, the faucet body including outlet openings for coupling to outlet pipes located behind the vertical wall for supplying temperature regulated water to the bathtub spout and shower head, said housing comprising:
a. a mounting flange provided for mounting said housing to an opening in the bathroom wall in proximity to the water faucet body;
b. a box section extending from said mounting flange and through said bathroom wall opening, said box section comprising a horizontal upper wall, a horizontal lower wall and an access opening therebetween, said upper and lower walls including a plurality of openings for aligning the water supply pipes and the outlet pipes to facilitate the coupling and decoupling of the pipes to the inlet and outlet openings of said faucet body; and,
c. a panel for attachment to the mounting flange.

2. The housing of claim 1, wherein said panel includes a decorative outer surface, having a polished finish.

3. The housing of claim 1, wherein said panel includes a decorative outer surface formed of tile.

4. The housing of claim 1, wherein said at least one water supply line includes a hot water supply line and a cold water supply line.

5. The housing of claim 1, wherein said at least one outlet pipe is an outlet pipe extending upwardly from said faucet body to connect to the shower head.

6. The housing of claim 1, wherein said at least one outlet pipe is an outlet pipe extending downwardly from said faucet body to connect to the bathtub spout.

7. The housing of claim 1, wherein each of said upper and lower walls includes an opening for the passage of an outlet pipe therethrough, said lower wall comprising two additional openings for the passage of a hot and cold water supply pipe therethrough.

8. The housing of claim 7, wherein said outlet pipe passing through said upper wall extends to connect to the shower head and the outlet pipe passing through said lower wall extends to connect to the bathtub spout.

9. The housing of claim 1, wherein said mounting flange is provided with a plurality of openings thereon to facilitate attachment of the mounting flange to the bathroom wall with suitable fastening means.

10. The housing of claim 10, wherein said fastening means comprise a plurality of screws.

11. The housing of claim 1, wherein said box section additionally comprises vertical side walls attached at the ends thereof to said horizontal upper and lower walls to form a box shape.

12. The housing of claim 1, wherein the water faucet additionally includes cold and hot water handles mounted to the bathroom wall for regulating the temperature of water exiting the faucet body.

13. The housing of claim 1, wherein the water faucet additionally includes a singe handle mounted to the bathroom wall for regulating the temperature of water exiting the faucet body.
